(19) United States
(12) Patent Application Publication
(10) Pub. No.: US 2008/0114555 A1
(43) Pub. Date: May 15, 2008

(54) Fast Extrapolation of a Thermal Sensor's Final Value and Discovery/Verification of a Thermal Sensor's Thermal Time Constant

(76) Inventor: Jonathan B. Scott, Hamilton (NZ)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/539,346

(22) Filed: Oct. 6, 2006

(51) Int. Cl. G06F 19/00; G06F 17/40

(52) U.S. Cl. 702/66; 374/43; 374/45; 702/1; 702/127; 702/57; 702/60; 702/187; 702/189

(57) ABSTRACT

A power meter that uses a thermal mount whose response to changes in applied power is exponential, is equipped to digitally sample the conditions within the mount at a rate of many times per time thermal constant. Samples are monitored for an indication that a significant change in power level is occurring. When that condition is detected a forward extrapolation computational algorithm is performed upon several consecutive samples that may be taken over approximately the duration of one time constant. The extrapolation is a prediction the final value that would be obtained for the power sensor's indication of that same applied power after five time constants. The first of the several samples may occur immediately upon or shortly after the discovery that a significant change in power has occurred. An actual step in applied power need not last longer than the time during which the several samples for extrapolation are taken in order to be measured. Extrapolation may be performed continuously whenever significant change is detected. Extrapolation needs the time constant(s) for the mount in use, or some exponential rule that governs its behavior. Absent that information the power meter can find the thermal time constant of the mount, which it may then store in the power meter or in the mount itself. Similar extrapolation works for electronic thermometers having thermal probes having a thermal time constant.

### INTRODUCTION AND BACKGROUND

Certain measurement techniques depend upon change in a sensor's temperature to provide an indication of the thing being measured. The ‘thing being measured’ might be a temperature itself (e.g., “Does this patient have a fever?”) or a value describing a property of something else that causes a change in the temperature of a sensor exposed to that property. Sensors used in this manner include simple resistors whose resistance changes ‘a little’ as a function of their temperature, thermistors whose resistance changes ‘a lot’ as a function of their temperature, and thermocouples, whose output voltage varies according to the temperature of the junction within the thermocouple. Let us call such sensors ‘thermal sensors.’ The correlation, or mapping, between measurable output resistance or voltage on the one hand, and the ‘input’ on the other, varies in complexity in known ways, and serves as the basis for measuring the thermal sensor's output and presenting the results in units describing the input applied to the thermal sensor.

An ‘electronic thermometer,’ then, is generally a thermal sensor (probably disposed in a probe assembly of some sort) usually connected to what is essentially an ohmmeter (for measuring resistance) or a voltmeter and whose display is calibrated in temperature. (We say ‘usually connected to . . . ’ because there are other thermometer techniques that can benefit from what follows.)

One very common way that RF (Radio Frequency) power is measured to couple that power into a resistive termination at the end of a transmission line, and then measure the temperature change in the resistive element. Thermocouples, thermistors, barretters and bolometers are examples of power sensors of this sort that have been developed for use well into the microwave region. In each case the applied RF energy results in power dissipation that causes an increase in the temperature of the sensing element. Whether the parameter monitored is voltage or resistance is not particularly important, and we can generalize a bit and simply say that applied RF power is dissipated as heat and produces a measurable change in some output.

A ‘mount’ of some sort is generally used to house the sensor and provide a low SWR (Standing Wave Ratio) RF connector of a desired type (e.g., N, APC-7, APC-3.5, SMA, 2.4 mm, etc.) through which is applied the RF signal whose power level is to be measured. Some mounts accept RF power through a waveguide and its associated flange. A cable connects the ‘mount’ (e.g., a ‘thermistor mount’, a ‘thermocouple mount’, a ‘bolometer mount,’ etc.) to a ‘power meter’ whose job it is to indicate the amount of applied RF power based on a measurement of the change in conditions within the mount. The earliest designs provided for ‘zeroing’ the power meter with no RF power applied, then applying RF power, noting the change in the monitored parameter and then indicating such as the measured power level. The zeroing operation was needed to offset the effects of ambient temperature, as well as to adjust for the particular instance of the mount in use. Before long there appeared ‘temperature compensated’ mounts that have two sensors, both exposed to the same ambient temperature, but only one to the applied RF. Now what was measured was the change in output between the two sensors, assuming that some balance was previously produced before RF power was applied. We might call this a differential measurement approach, as only an actual difference is what is measured, the better to discriminate against the effects of changes in the temperature of the ambient environment (commonly termed ‘drift’).

Another approach is exemplified by the ‘calorimetric power meter,’ where two identical sensors are kept at a common (but not necessarily constant!) ambient temperature through an interconnecting low thermal resistance path, while RF power was applied to one sensor. The power meter detects a change in output between the two sensors (as in a bridge circuit) and nulls that difference by driving the other sensor element with a separate source of power, generally using just DC. Measuring the amount of DC power needed balance the bridge is equivalent to measuring the applied RF power. It is a good practice to keep the two sensors and their low thermal resistance path well isolated from the outer ambient thermal environment. We might call this a balanced measurement approach, as it is the balancing amount of power delivered to the other sensor that is actually measured and reported.

Both of the differential and balanced power measurement architectures are in use with a variety of sensor types, and each has some desirable characteristic that makes it suitable for certain applications. Some balanced designs have allowed as little as one milliwatt and as much as ten watts to be applied directly to the RF input without benefit of an intervening attenuator. Other designs are very sensitive and have a full scale reading for a very tiny amount of applied power (say, −60 dBm, or one millionth of a milliwatt, or even less). Both approaches share some common properties or behaviors that are of interest.

One aspect of power meter performance that is of interest is the speed with which a measurement can be performed. To be more precise, if there has been a significant change in the level of applied RF power, how long does the mount/power meter combination require to provide a correct reading? A similar concern attaches to temperature measurement probes. The fundamental issue here is not so much the speed of the electronic measuring circuitry in the power meter/thermometer proper: it is more an issue having to do with how long the thermal sensor element takes to completely change its temperature in response to a change in an applied input. In short, a thermal sensor has a thermal mass that must gain or lose heat to effect a change in temperature. Furthermore, that gain or loss of heat of the thermal mass for the sensor will be through some thermal resistance, and may involve another thermal resistance to an ambient temperature assumed to be constant (at least in the short term). This is equivalent to the changing voltage across a capacitor as its charge changes in response to a new voltage level applied through a resistance.

As is well known, such rates of change are exponential, in that the rate of change is proportional to a remaining difference produced by previous change. As the difference decreases, so does the rate of change. In principle, the change is never really complete, but in practice, a period of time known as the time constant is useful in predicting when a response to an applied step is essentially complete. The usual rule of thumb is that after five time constants almost all (approximately 99%) change in response to an abrupt step has occurred, and any remaining change will take disproportionately long to occur. A time constant for a capacitor is the product of the capacitance and the resistance to charge/discharge. After one time constant approximately 63% of an abrupt step will appear across the capacitor. Thermal sensors have thermal capacity (thermal mass), and thermal resistances to the flow of heat within themselves and between themselves and other thermal environments. Thus, thermal sensors exhibit thermal time constants (usually denoted by the Greek letter tau: τ). The five time constant rule of thumb applies here, too.

As its name suggests, a time constant is a length of time. Some are long, and some are short. The ten watt calorimetric monster mentioned earlier has a physically relatively large sensor (you can melt solder with less than ten watts!), and has a time constant on the order of half a second or more. On the other hand, the truly sensitive sensors are quite small (they can be destroyed by the heat generated by a modest static discharge), and can have time constants as short as one or two hundred micro-seconds. Sometimes a thermal sensor has more than one exponential relationship that explains its behavior to an abrupt change in applied input. In these cases a more complicated exponential relationship is better used in place of the notion of a simple time constant.

There are applications where it would be desirable for a thermal sensor/thermometer combination or thermal RF power sensor/power meter combination to be able to make accurate power measurements at a rapid rate. These are often connected with operation within some sort of servo-loop, such as maintaining the temperature in a controlled environment or leveled RF power for a swept source that sweeps at a rapid rate. Or, suppose that the power level of a pulse in a pulse modulated carrier is what is to be measured. In such a case the greatest need is for the duration of the measurement to be short (as if it were a ‘sample’), and perhaps be performed in response to a trigger of some sort. In either of these cases, and in others, the full five time constants may well be too long a time to wait: The condition being measured does not remain static that long, erratic results are obtained and the measurement apparatus is seen as the wrong tool for the job.

Much development has already gone into present day thermal RF power sensors. While we can wish for one with a shorter time constant, it might not do us as much good as we might at first expect. Smaller time constants for low levels of applied power are associated with small thermal mass, which means small size, heated through a low thermal resistance. Small sensors are well suited for small amounts of power (−60 dBm is not much power to heat anything, and the expectation is that we will measure IT itself as directly presented, and NOT after some amplification . . . ). Small sensors are relatively delicate, and if they were any more so might not readily withstand the occasional overloads and other rough treatment that such things are prone to receive.

Furthermore, it is not uncommon for the low output levels produced by certain types of sensors (e.g., thermocouples) when operated at low input levels to receive assistance from a chopper stabilized amplifier (a technique for converting a low level signal into an AC signal that can be greatly amplified without drift in the internal conditions of the amplifier being mistaken for a change in the input signal itself). Those things typically operate at around the higher audio frequencies (e.g., 20 KHz) and that will impose an upper bandwidth limit that obscures the presence of a short time constant. Further still, signal to noise ratios often get pretty disgusting at the lowest signal levels, prompting the power meters designers to reduce its internal bandwidth severely, say, to below one hertz. (On the lowest ranges it can take seconds to get a reading!) Again, this obscures the presence of a sort time constant in the thermal sensor. Accordingly, it may well be desirable to retain the use of existing power sensors with modest time constants, or use newly developed ones whose time constants are not ‘short.’

But on the other hand, there are still times when we should like our thermometers to have as short a response time as possible, and we retain the urge to measure power levels at a rapid rate, including shortly after the onset of a significant change, all as though the thermal time constant were short, even though it might not be. Perhaps there is something we can do within the measurement apparatus itself to allow fast measurement of either significant change or abrupt steps in an input applied to a thermal sensor whose time constant is ‘too long’ and thus avoid having to re-invent the thermal sensor.

These days, everything from washing machines to automobiles has a small microprocessor, and electronic test equipment is no exception (and some of their processors are not ‘small’). So, instead of trying to re-invent the thermal sensor, perhaps its accompanying thermometer or power meter can itself be made to ‘better understand’ the behavior of an otherwise conventional thermal sensor. Furthermore, since the notion of ‘better understand the behavior’ of a thermal sensor would seem to involve the thermal time constant of that sensor, and since it might be the case that neither we nor the measurement apparatus know the actual thermal time constant of a thermal sensor we intend to use, perhaps the measurement apparatus can also be made to discover the thermal time constant of the thermal sensor in use. These are fine plans, but how to do it?

### Simplified Description

An RF power meter that uses a thermocouple, or other style thermal RF power sensor mount whose response to changes in applied power is exponential, is equipped to digitally sample the conditions within the mount at a rate of at least twice, and preferably many times, in approximately one thermal time constant. During times of operation when fast response to significant changes in applied RF power are of interest and the power meter's bandwidth is not deliberately reduced to the point where the sensor's thermal time constant is obscured, the digitized samples are monitored for an indication that a significant change in RF power level is occurring. When that condition is detected a forward extrapolation computational algorithm is performed upon several consecutive digital samples that may be taken over approximately the duration of one time constant. The consecutive digital samples need not be equally spaced, although it is a computational convenience if they are. The extrapolation is a prediction of the eventual asymptotic (final) value that would be obtained for the thermal RF power sensor's indication of that same applied power after five time constants from the first of the several samples. The first of the several samples may occur immediately upon or shortly after the discovery that a significant change or abrupt step in applied power has occurred, and to be correctly measured an actual abrupt step in power need not last longer than the time during which the several samples for extrapolation are taken. To do this we need to know the time constant(s) for the mount in use, or some exponential rule that governs its behavior when exposed to an abrupt change in power level. In cases where the exponential relationship is more complicated than a simple exponential relationship for just one time constant, this technique can still be applied by knowing the nature of that more complicated exponential relationship, and extrapolating it for suitable amount of time, just as in the simple case. By characterizing the change in the vicinity of the first time constant when the rate of change is greatest we gain very quickly almost as accurate an indication of where the final value of measured power will settle as if we waited for it to actually settle.

In the case where the amount of applied power remains essentially constant an average of the last several digitally sampled measurements may be reported in place of the extrapolation. However, once a significant change in power level is detected, the extrapolation algorithm can be invoked continuously until such change has abated, with the risk of only minor overshoot.

The extrapolation technique can be used in both differential and balanced measurement techniques of RF power measurement. That is, it can be used with samples of significant changes in a thermocouple's junction voltage (or a thermistor's resistance) as readily as it can with digital samples of a compensatory power feedback signal used to null a sudden significant difference between applied power and the feedback power.

A comparable technique is applicable to thermometers, where typically the voltage or resistance of a single thermal sensor is measured, say, with a digital technique and reported in the desired units (e.g., degrees Fahrenheit or Centigrade).

A thermal sensor may have its thermal time constant (or other exponential description of its response) encoded therein for communication to the power meter or thermometer. For use with older sensors that do not operate in that manner but which are otherwise desirable, the measurement apparatus may allow the manual specification by the operator of a time constant or other response description.

The same relationship that describes a thermal sensor having a single thermal time constant can be further exploited to discover that thermal time constant if a known abrupt step in power or temperature is applied. To facilitate this a known pulsed calibration power level source may be included in a power meter that is also equipped to discover the sensor's time constant while it is being used to measure that source of known pulsed power. The discovered time constant may be stored in the power meter or within the mount itself. The time constant of a thermal sensor for a thermometer can be found by creating an abrupt change to a known temperature, say, from room temperature to that of the surface of an ice cube, and assuming the temperature there is the triple point of water.

### BRIEF DESCRIPTION OF THE DRAWINGS

FIG. 1 is a simplified block diagram of a power meter that uses a thermal power sensor, and illustrates the fundamental exponential nature of the power sensor's response to steps in measured power;

FIGS. 2A-B are a simplified development of an extrapolation technique usable for thermal power sensors that have a single dominant time constant, and are readily described by a simple exponential relationship;

FIG. 3 is a simplified flowchart describing the steps of a method of implementing the extrapolation set out in FIGS. 2A-B;

FIG. 4 is a simplified development of a computational techniques usable for discovering the thermal time constant of a thermal sensor;

FIG. 5 is a simplified flowchart describing the steps of implementing the discovery set out in FIG. 4; and

FIG. 6 is a simplified block diagram of temperature measurement by a thermometer and that can use the extrapolation techniques set out in FIGS. 2-5.

### DETAILED DESCRIPTION

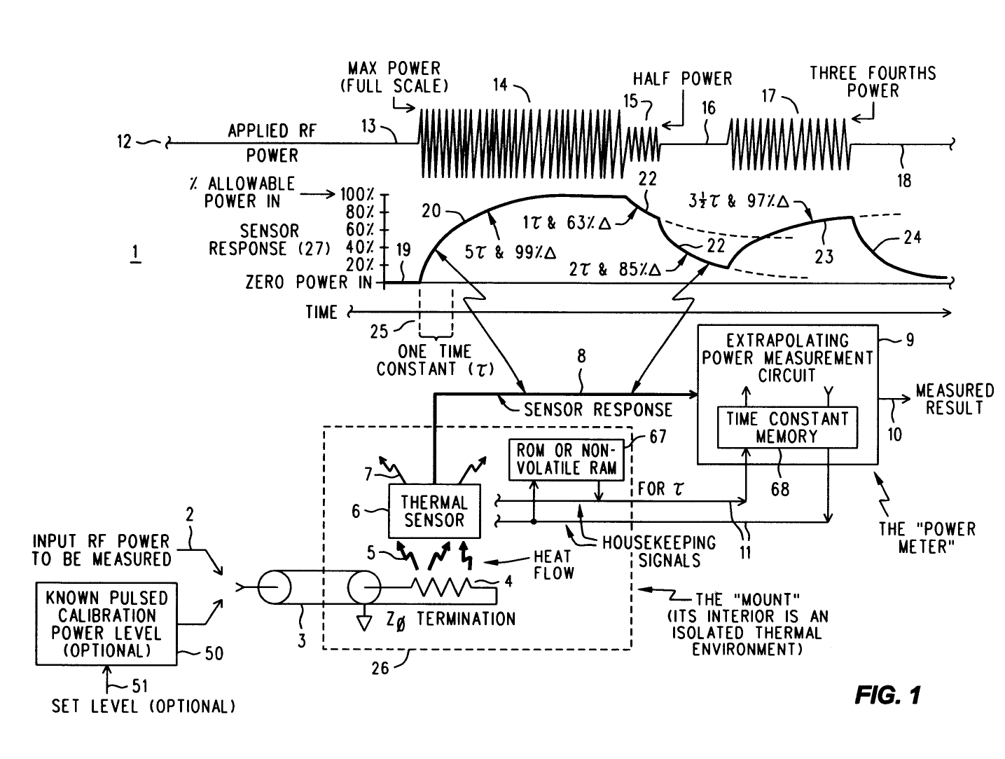

Refer now to FIG. 1, wherein is shown a simplified representation of an extrapolating power measurement apparatus 1 that uses a thermal sensor 6, which may be based on thermocouples or a temperature sensitive resistance, such a thermistor or a wire. An RF signal 2 whose power is to be measured is coupled via a transmission line 3 to a resistive termination 4 whose effective resistance at the frequencies of interest (which is frequently well into the microwave region, perhaps even in excess of 100 GHz) is Z₀, or the characteristic impedance of the transmission line. The power within the RF signal is absorbed and dissipated as heat by the termination 4. (We have shown the thing that dissipates the RF energy and ‘gets hot’ (4), and the thermal sensor (6) that is thus warmed and changes its output, as separate items, probably quite close together. Sometimes this is just how it is. Other times the two are actually the same thing. The separate case is perhaps electrically simpler, although that is not an issue here. Conceptually, both are equivalent for our purpose, and since the separate case shown is logical and easy to appreciate, we use it here. It will be understood that it stands for both cases.)

At least a portion of that heat flows (5) into the thermal sensor 6, where it causes some sensor response 8 that is measurable by an extrapolating power measurement circuit 10 that corresponds to what is typically thought of as ‘the power meter.’ The combination of the termination 4 and the thermal sensor 6 are generally thought of as the ‘mount’ (26) of some sort, as in a ‘thermocouple mount.’ The mount and the power meter might be separate catalog items connected by a cable, with the idea that many different types of sensors might be usable with a particular power meter, and vise versa. On the other hand, there are also embedded applications where the whole power measurement activity is permanently contained as a ‘component sub-system’ within some larger apparatus. The topic we are about to discuss in this patent is applicable to both situations.

To continue, either of the afore-mentioned power measurement strategies (differential, balanced) can be used in connection with the extrapolation technique to be described in course. That is, the sensor response signal 8 might be an actual analog difference related to two sensors operated at different powers (one power to balance ambient differences with no RF power applied, and the other to register the RF power when applied), or it might be a measurement of an identical DC power provided by the power meter to match and thus null (balance) the difference (imbalance) between the applied RF and that matching power. Thus, the sensor response signal 8 we have shown is, for a modern power meter, an equivalent, or logical, characterization of some particular mode of activity involving many signals, and is unlikely to be a solitary signal on a single conductor (i.e., a single-ended signal referenced to ground).

That said, we are bound to point out that there exists an older (non-compensated for ambient temperature) technique where just one thermistor or bolometer element actually did send to the power meter a single ended signal on a center conductor shielded by ground. The only correction for drift was to zero the meter with the RF off to null out the sensor's ambient temperature signal, and the admonition was to then hurry up and make the measurement before there was more drift. For reasons that are not hard to appreciate, this manner of operation is not currently in favor. Our reason for mentioning it at all is that the extrapolation technique we are about to set out will work just as well with such older, less convenient power measurement practices, even though it does not remove the need for the admonition to hurry nor fix their other shortcomings. Furthermore, some thermometers still work in essentially this ‘single signal’ manner, and the signal levels involved are such that zeroing and drift are usually not significant issues.

It will be noted in FIG. 1 that we have shown transmission line 3 as receiving input RF power to be measured (2). This is the ‘customer's input power. There is shown in the figure another source of power: Known Pulsed Calibration Power (50). This is a pulsed source of power that can be used to verify that the extrapolation to be described is functioning correctly, or alternatively, to discover the thermal time constant τ for the mount in use. How these things are accomplished will be described in connection with subsequent figures, and for now it is sufficient to describe what the thermal sensor 6 is exposed to when the mount 26 is connected to the Known Pulsed Calibration power jack on the front panel of the power meter (alternatively, the source of pulsed calibration power might be a separate accessory).

The source of known pulsed calibration power level 50 can be a source of RF power that switches between OFF and some convenient ON level (0 dBm or thereabouts is good) at a suitable rate slow enough to allow the slowest likely thermal time constant to be accurately discovered. Say, that were likely to be about a millisecond. Then a rate of about five milliseconds ON and about five milliseconds OFF would produce a period of around ten milliseconds, or a frequency of about one hundred Hertz. That essentially describes a square wave AM (Amplitude Modulation) envelope for a suitable RF carrier of, say, the customary 30 or 50 MHz. The ON power level could be set to +3 dBm, so that the average power would be a safe (and usual) one milliwatt. (On the other hand, we might make the ON power level selectable (according to signal 51), the better characterize the mount's performance at about the same level as we expect to use it. This could mitigate an error caused by assuming that our sensor is ideal, etc., when strictly speaking, perhaps it isn't.) We should like the rise and fall times of the modulation envelope to be reasonably fast, perhaps never more than a tenth of the shortest τ that we are apt to encounter. That should not be at difficult, as the actual rise time for a 30 MHz signal's modulation envelope could easily be not much more the duration of the quarter cycle needed to construct it, and that length of time is way shorter than any value of τ that we are apt to encounter.

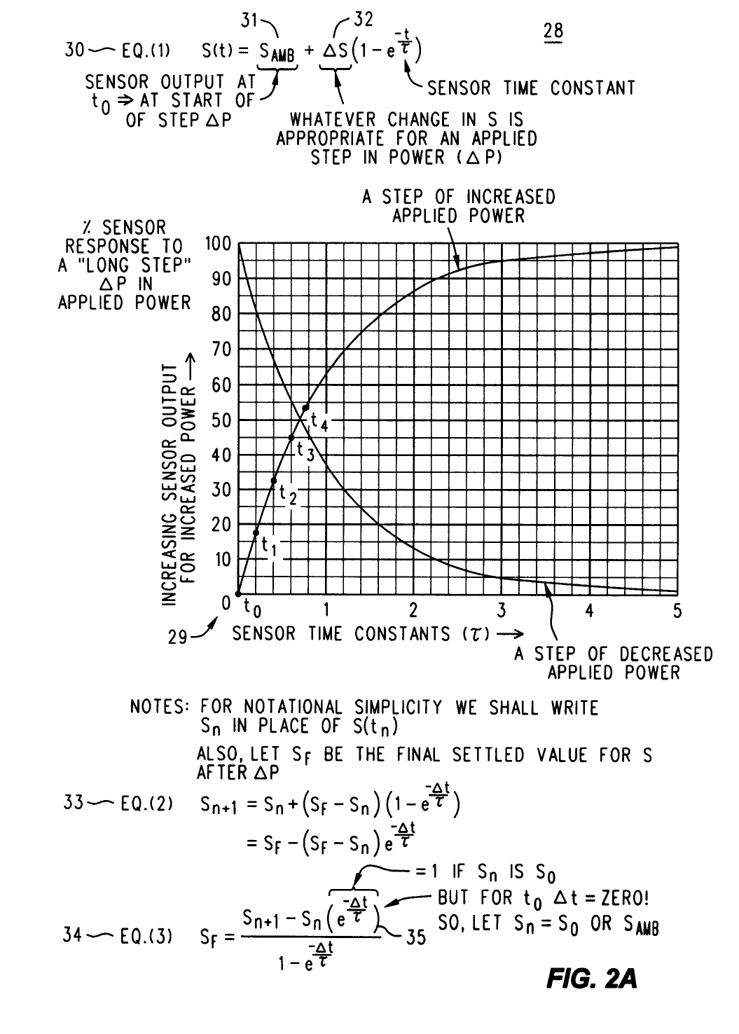

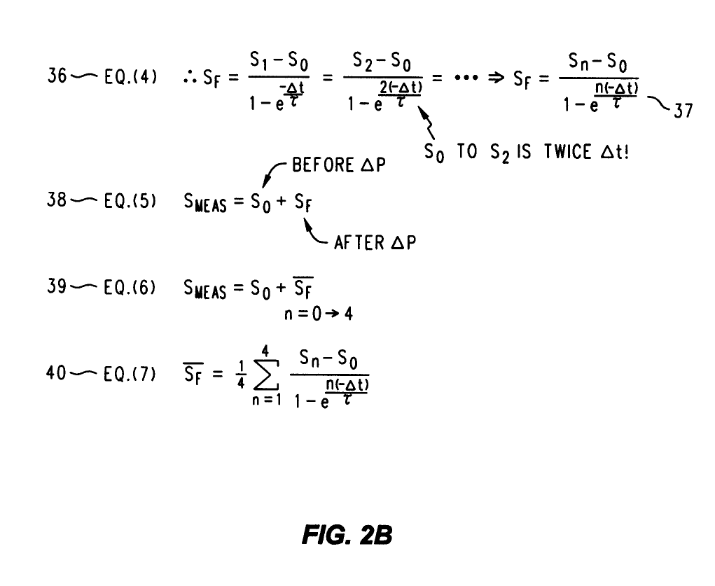

To continue, the thermal sensor 6 is thermally coupled to the RF-power-related source of heat (termination 4) by a thermal resistance 5, and also to other portions of the thermal environment within the mount 26 by some thermal resistance 7. This arrangement gives rise to a thermal time constant (25) that is conventionally represented by the Greek letter tau (τ). For the present, and for simplicity, kindly assume that the source of heat (4) and the destination (6) of some portion of that heat (we can't expect to get it all) are small enough, or at least isolated and homogeneous, that they are well characterized as being discrete point-like entities. Also assume that thermally resistive paths 5 and 7 are ‘like pipes.’ Under these rather idealized conditions (a nice linear network) there will effectively be one time constant whose behavior is well described by a simple single exponential relationship that is well known (and discussed in connection with FIG. 2). This is not an unreasonable set of assumptions, as there are many practical thermal power sensors (and thermal temperature sensors) whose behaviors are quite adequately described in such a manner.

So, the situation described so far is essentially this. An otherwise conventional sort of thermal power sensor having a thermal time constant τ is operated with an appropriate power measurement circuit, which preferably operates in a digital manner. That is, it contains all the usual components of a small embedded system: a processor, RAM (read-write Random Access Memory), ROM (Read Only Memory) and assorted DACs (Digital to Analog Converters), ADCs (Analog to Digital Converters), display mechanisms and interface circuits, all as may be needed. As this manner of electronic measurement construction is conventional, we have omitted such level of detail from this Description. Furthermore, insofar as this combination operates without extrapolation, it does so with whatever measurement technique is in use (i.e, what is the measurement strategy behind the creation of the sensor response signal 8). We say it this way to emphasize that the addition of the extrapolation technique does not alter whatever manner of interaction there will be between the thermal sensor elements themselves (stuff inside 6) and the power measurement circuit 9. That is, as to responses from the power measurement circuit 9 to any applied RF power that the mount 26 and its thermal sensor 6 experience, the mount and the thermal sensor cannot tell if extrapolation is in effect or not. Said another way, we are not going to disturb the operation of the thermal sensor, per se. What we are going to do is change how we decide what the sensor response signal 8 means. Under circumstances suitable for extrapolation, the measured result 10 from the extrapolating power measurement circuit 9 will be different than before, and that difference is in how the power meter decides to report a measured result.

Before we leave the bottom half of FIG. 1 there is one final topic to mention. Notice the housekeeping signals 11. There are various tasks that these signals might accomplish, and they might even be properly construed as involved in some sort of zeroing activity. We have in mind another class of activity that involves the transmission of information, such as to assist in the division of labor for a modern mount/power meter combination. Recall that this is likely a mix and match environment, where the days where a particular sensor being permanently matched to certain instance of power meter are long gone. Yet despite this ‘relaxation,’ accuracies are considerably improved. In no small part this improvement is due to the encoding of calibration factors in the mount that are retrieved and used by the power meter. Model number and serial number are examples of other useful information that is typically encoded in the mount. We do not wish to interfere with this, and indeed, have in mind that we should extend it somewhat to cooperate with the extrapolation technique.

It will become apparent that τ needs to known by the power meter to perform the extrapolation operation that we are interested in. The value of τ might be discovered at the factory and permanently encoded in the mount, just as are other mount-related descriptive information, and then conveyed to the power meter over the housekeeping signals 11. In this connection, note the memory 67 in mount 26. It may be a ROM or a non-volatile RAM (e.g., FLASH memory) that stores this information, including the value of τ. (We note also that there might be more than one value of τ stored in the mount, along with an indication of when each should be used.)

In the absence of such convenient storage of τ in the mount itself, we can imagine a calibration exercise that the power meter and operator might cooperate in to discover τ, whereupon it can be suitably remembered by the interested parties, which includes storing it in memory 67 within the mount itself, and/or, within a time constant memory 68 that is part of the power meter proper. Last (and worst) the poor operator might be forced to read some indication of τ off the (frequently beat up) hide of the mount and enter it somehow into the power meter. That would surely be for the economy model, and we confess that we prefer the convenience and utility of the house keeping signals 11 for communicating τ. It will be appreciated, however, that a mount supplied thermal time constant is not, strictly speaking, needed for task of extrapolating significant changes in readings.

Now consider the top half of FIG. 1. Let us begin with the graph 12 of applied RF power. We mean it to be a true power waveform for some carrier or other RF signal, and it exhibits a region (14) of ‘full power’ (according to some gradation effected by the power meter, say it is +10 dBm, for example), regions (13, 16, 18)of no power, a region(15) of half power (i.e, half the +10 dBm, or+7 dBm), and a region (17) of three quarters power.

We begin with the observation that region 13 extends back in time quite a ways (way more than five τ) and that accordingly, the corresponding sensor response signal 8 (whose graph 27 is shown below the power graph 12) is also zero at region 19. (Once again, we caution the reader not to assume that this means that some voltage or current signal to be measured within the power meter 9 is also zero—although it might be, even though such is improbable. We mean that some condition identified ‘with no power in’ is occurring, and exactly what that is in terms of electrical signals depends on how the particular power meter/thermal sensor combination operates.)

Now consider an abrupt zero to full scale step in applied power. Region 14 represents such a step. The corresponding behavior of the sensor response signal 8 is shown as region 20, and is the familiar exponential rise that practitioners of the electronic arts are all familiar with. In this case, it is the thermal time constant τ that is responsible, not some RC time constant, but we see the same kind of behavior. At the end of one time constant the rise in region 20 is 63%, and has reached 99% by 5τ.

At that point in time the power level changes abruptly to half power (region 15) for a duration equal to one τ. During that time region 21 exhibits an exponential decay to 63% of the way toward its destination of half power (see the dotted extension of region 21). At that time power drops again to zero for 2τ. In two time constants the change (region 22) will be to about 85% of the way toward ultimate destination (in this case zero), but of course, at the end of those 2τ power again changes abruptly, this time to three quarters power (region 17), and the response begins an exponential climb toward three quarters power. The total change needed is only from where it was at the end of region 22 to three quarters, however. The duration this time is 3.5τ, for a change (23) of 97% of that total. Finally, note region 24, which is an exponential decay toward zero, corresponding to region 18. We can't tell if it makes it to zero, or not. This manner of sensor response will not be mysterious to the reader familiar with time constants or exponential functions of the sort to be described next in connection with FIG. 2.

Now refer to FIGS. 2A-B, which constitute a development 28 of a forward extrapolation technique usable with a thermal power sensor whose response is essentially characterized by a single exponential relationship. We begin with the graph 29, which will be recognized as the venerable ‘universal time constant chart.’ It shows both the exponential rise and exponential decay of a property as a function of time expressed in units of time constants. These shapes are essentially the same ones encountered in regions 20-24 of the sensor response graph 27 in FIG. 1.

Note the five locations (points) along the first time constant: t₀, t₁, t₂, t₃ and t₄. For now, we assume that t₀ is located at the very start of the exponential rise (or decay), and that the four intervals between the five points (which interval we shall call Δt) are all equal. These assumptions, as well as the one that there are five points, as opposed to some other number, and that they are all taken from the first time constant, are merely convenient for the explanation that follows, and will be further examined and relaxed in due course.

Now consider Eq. (1) 30 and its use of the term S_{amb} 31. It will be appreciated that the far right term accounts for the exponential behavior, while the term S_{amb} represents from what existing value the exponential behavior commences. This way of looking at things assumes that the impetus for change (for now, assume it is an abrupt step) has just occurred; that is, S_{amb} is what the value S(t) was at the start of the abrupt step. This is why we have located t₀ at the start of the region of exponential rise or decay. This is just a convenience, however, and if t₀ were, say, where t₁ is and the other points similarly translated to the right, no harm would follow. One way we could patch things up would be to consider the abrupt impulse of power as ‘really’ being two consecutive ones that are adjacent, and that now we are only considering the second one, and t₀ is where the output was when the first impulse ended and the second started. This clever fiction is made possible because the magic of the exponential relationship of interest is rooted in the notion that it does not really ‘know’ where things start and end, only ‘how far they are supposed to go’ independent of ‘where they were at the start.’ This sentiment explains why we are content to put t₀ at the start of the abrupt step in applied power, and leave it there, ‘even if it really isn't’ (say, because there was some power there already . . . ).

Furthermore, it is not clear at this point in the analysis that S_{amb} is necessarily a zero RF-power-in sensor output that is produced by an ambient temperature, or, that plus some steady level of RF power. To clear this up we shall say that any attempted S_{amb} owing to ambient temperature alone is known and has been already removed from the sensor response signal, or if not, will be removed from the final reading sent to the user. As to an S_{amb} that arises from some existing RF input present at the time the step occurs, it turns out we can ignore it for now by simply assuming that it is either zero, or by reassuring ourselves that it is on hand already, and that if we needed to know what it is (a final S(t) that was produced earlier) we could.

To conclude our discussion of Eq. (1), note the term ΔS (32). It represents the ‘how far things are supposed to go’ idea of the previous paragraph. When we look at Eq. (1) at the time of the application of the step in power we appreciate that ΔS has to manifest itself somehow, since it is successive fractional amounts of that value which are what are accumulated to S_{amb} to produce the individual S(t) as time passes. But when it (the step) happens WE don't know what that ΔS is, and in fact, we are curious to find it: THAT is what the power sensor/power meter combination is supposed to do for us. Now, to be sure ΔS is definite; it is the (new, let us say, greater) applied input. The mount experiences it, and by virtue of its being a transducer, the extra power associated with ΔS is instantly in being within termination 4 and oozing its way into the sensor 6. The various S(t) are what we DO know, and if wait the entire five tau the full ΔS will eventually have been added (piecemeal, as it were) to S_{amb}, and we will have our answer, as some eventual S(t). ΔS would then be revealed as the difference between the last S(t) before the applied in power and the newest one (a settled S(t)).

So, ΔS represents some settled final incremental value that will be revealed through the exponential relationship. We'd like to find it without waiting for five τ to see it as a change in S(t). So let's call S_{amb}+ΔS by a new name S_{f} (for S_{final}), and let the algebra begin.

Eq. (2) is an operational, or time series, expression (33) of the relationship embodied in Eq. (1). It simply says that the next value of S (an Sₙ₊₁) is the old previous value (Sₙ) plus some fractional part of the change being attempted (which is some portion of the step there yet remains to go, based on what happened earlier . . . , and so on).

We re-arrange and simplify Eq. (2) as Eq. (3) to isolate S_{f}. We omit the gory details of how this is done (this is the famous ‘exercise left for the reader’ trick). The important thing about the general form of Eq. (3) is that it tells us S_{f} for any two points along the exponential change! There is, however, one particular thing to note about the relationship 34 of Eq. (3): observe the exponential term 35 in the numerator. The legend in the figure draws our attention to the fact that when t₀ is afoot (i.e., when n=0) then Δt is also zero, and the whole exponential term becomes ε⁰, or just one. That is, the numerator of the right-hand member of Eq. (3) is simply S₁−S₀. We already know what S₀ is: it is S_{amb}.

We are now in a position of instantiate Eq. (3) for say, n-many equally spaced points: t₀, t₁, t₂, t₃, and t₄. This is done as Eq. (4) 36. In each case, we choose to use t₀ as the anchor of the interval defined by the other point. In this way, there occurs an expression with just a unit Δt (for t₀ to t₁), one with twice Δt (for t₀ to t₂), and so on, with the general expression involving the product 37 of n and (−Δt). So, if we have five points t₀-t₄, we can find S_{f} four different times! That is, we could evaluate Eq. (5) (38) four different times. Phooey. Instead, we would rather evaluate Eq. (6) (39), which uses the average of the four different S_{f}. Eq. (7) (40) is the final closed form expression we can evaluate to find the average S_{f} for our five points t₀-t₄, which we then substitute into Eq. (6) to get the real answer, S_{amb}.

Some final observations about this extrapolation. First, it is not a curve fit or regression used to identify what relationship is at work. We presume we know THAT already. If we wanted to, we could do this extrapolation with just t₀ and one other point, t₁. Or, we could use any number of points for the average of S_{f}, as long as each was used with the same t₀. Now about this business of the points t₀-tᵢ being equally spaced. It is now clear why this is merely a convenience, and not a requirement. If the tᵢ were not equally spaced, then all that would ‘go wrong’ is that each Δtᵢ would be some different value. That does not mean we would not know what they would be: tᵢ-t₀ is what they would be. The rub is that we can no longer write n(−ΔAt) in Eqs (4) and (7), and must instead evaluate each S_{f} with its own Δtᵢ, and then find their averages the ‘hard’ way: separately find the individual S_{f}, add 'em up and divide by how ever many there are. Now, that's not so bad, is it?

FIGS. 2A-B have been used to illustrate the useful case where the thermal sensor has one significant time constant. In the case where a sensor has more than one exponential relationship that explains its behavior, then a different version of FIGS. 2A-B would start with that equation, and the same general process would ensue. A rule for finding S_{f} as a function of two samples would be produced, and from there the idea of using that or averaging two or more values of S_{f} remains as discussed above.

It will be noted that the explanation to this point has proceeded on the assumption that some abrupt step in power has been applied, and the extrapolation provides knowledge of the final settled value for that step, well before that settling actually occurs. We now need to relax this notion that an abrupt step is required for extrapolation to be useful. It can be shown that all that is really required is that there be a change, and that extrapolation is useful in reducing settling time, even though there may be some overshoot. As a practical matter, we prefer to invoke extrapolation only when it appears that ‘significant’ change is detected, say, the last five or seven samples of the sensor response signal 8 are monotonic, or that some threshold condition has been met. Say, samples taken at tᵢ₊₁ and tᵢ₊₂ are each more than 10% away from tᵢ (and in the same direction!). This does not force there to be an abrupt step in applied power, as a ramp or sinusoidal variation might as easily cause this behavior. Our assertion is that the extrapolation technique will, when applied to signals meeting such a ‘significant change’ criterion, continue to give a reasonably good result, with perhaps just a little overshoot. The reason for having the ‘significant change’ criterion at all is to assist in preserving noise immunity, rather than exacerbate it.

So, how is it that an extrapolation technique that was derived from an analysis of an abrupt step continues to work for other waveforms? For brevity, we omit a formal demonstration, and offer instead a motivation based on an analogous situation. Suppose we ramp the applied power from a starting level to a final level over a period of a few time constants. Let us say that Sᵢ are the amplitudes of the sampled sensor response signal. The less the slope of the ramp, the smaller the difference is between each of the Sᵢ, and the smaller is the value of the presumed asymptote for the supposed step. That is, the smaller the potential overshoot, or error in the extrapolation. As the slope of the ramp continues to decrease, even if the ramping persists for a long time, what happens is that the contribution from extrapolation becomes a diminishing portion of the reported result, as simple tracking of the input becomes an ever greater portion. On the other hand, to the extent that the slope of the change increases, the input appears more pulse-like, and we get an increasingly correct answer from the extrapolation, while the tracking component becomes more like the universal time constant curve (which is what the extrapolation assumes, and why it is essentially correct).

Now, there is one other consideration to note. Let's say there was a genuine step, and we detect it at its onset, predict its final settled value, and report that as the reading. Referring again to FIG. 2A, let's say we did all that shortly after having gotten our samples at t₀-t₄. We have not said that we should take advantage of ‘knowing’ that there really WAS a step, and shut down the sampling process during the second through fifth time constants, content to re-start it at some later time! Upon reflection, it is clear that it would be quite rash to make the assumption that just because the samples at t₀-t₄ LOOKED like those from a pulse, that there must now be one that actually persists as assumed. Instead, sampling and potential extrapolation continue as always.

So, let's consider a new set of samples that follow the first set, and that lies within the second time constant. If what caused the first set was a pulse that persists unchanged, then the second set will predict almost exactly the same settling value, only this time for one time constant (or so) further out. Indeed, if the pulse has stayed put, the settling value for the first set and the settling value for the second set will be within 1% of each other (ignoring noise and measurement error, etc.), since each is extrapolated to 99% of the same final settling value. Another way of looking at this is through the convenient fiction of partitioning a suitably long pulse into two adjacent shorter ones. The magic of the exponential relationship is that it does not care about where it starts, only when it starts, and how far it is supposed to go from where it already is. If it doesn't ‘get there,’ and is ‘redirected’ to begin a new change, it simply does so from its result so far. So, in the partition of one long pulse into two adjacent short ones, the same answer (trajectory of the sensor response signal) obtains in both cases.

But now suppose that the power level that caused the second set of samples was different than for the first: our pulse has changed its power level. Well, evidently we need to start finding out what the next settling value ought to be. Of course, we won't know that it has changed until we find it. When we do, we will say that the pulse changed its level, and this is now the right answer, just the preceding answer was correct at its point in time.

We could take groups t₀-t₄ as separate disjoint and non-overlapping sets of samples, as suggested to this point. That works, and it is simple to implement. And as far as this motivational explanation goes, it is an easy foot in the door, so to speak. But now suppose that to of the second group is really just t₁ of the first group, and so on. Has anything fundamental really changed? NO! But now our fictional partitioned pulse and its discovered variations can be as narrow at Δt. That is, we can refine our extrapolated estimate of what the settling value ought to be much more rapidly: at the same rate as the samples are taken. And what is more: the higher is the rate of the sampling relative to any actual rate of change in applied input, the smaller the slope appears to be, and the less error and overshoot we have to worry about, anyway, as mentioned above.

Another way to think of continuous application of the algorithm is that we have replaced the continuous power waveform with one which is a stair-step approximation with Δt resolution. This substituted version turns out to be a very satisfactory equivalent to the actual waveform, and one that the algorithm handles quite gracefully (according to the ‘adjacent pulse’ fiction).

So we don't have to call off the dogs, as it were, and shut down the algorithm after each use. We just let 'er rip! It will be appreciated that this rather long winded explanation can be replaced with an actual formal demonstration that passes to the limit, and that would support the use of a genuine filter, in place of the computational extrapolation, if that were desired.

It will be appreciated that the behavior we have described applies to power variations that are on the same order as the thermal time constant. Power variations that are much faster (one micro-second pulses, say) are simply averaged out into some overall level of power dissipation that appears constant. At the other end, power variations that are long compared to the thermal time constant are seen as a ‘moving target’ that won't stay still, and that is then tracked, just as any slow increase or decrease in power would be. In the first case, the algorithm never responds, because there is no change to extrapolate for. In the second case, the ‘significant change’ criterion protects us.

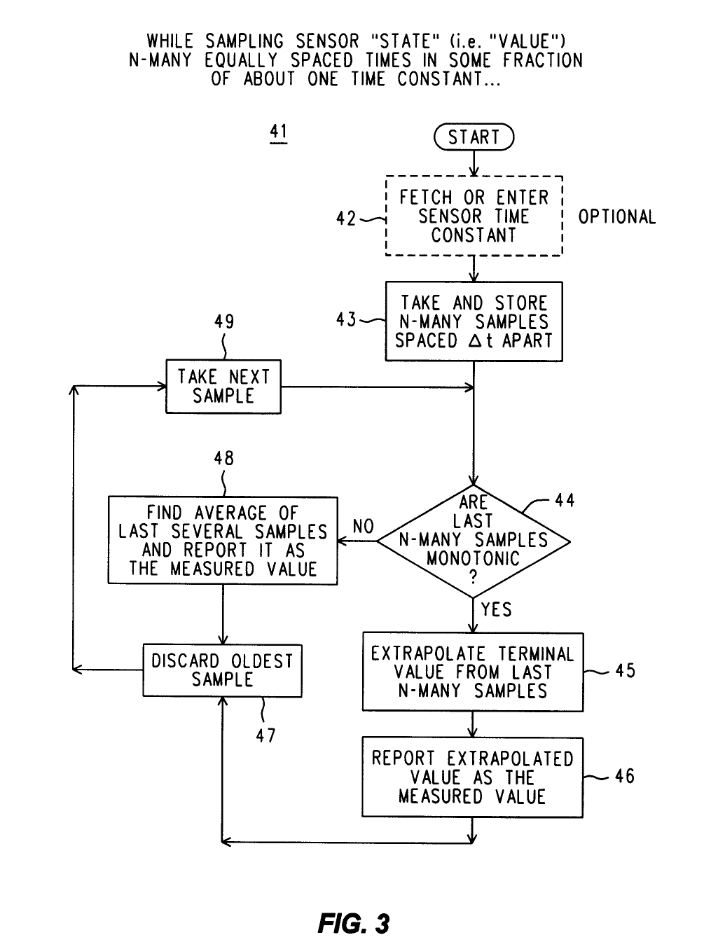

We now turn to FIG. 3, which is a simplified flowchart 41 of the extrapolation aspect of the operation of the block diagram 1 of FIG. 1. We should say at the outset that flowchart 41 is relevant when it is desired that significant change (which includes, but does not necessarily require, abrupt steps) in power have their terminal values found early by extrapolation (i.e., the operator may decide to enable or disable this feature as a mode of operation for the power meter), and the conditions of operation are such that extrapolation is not prevented by those operating conditions (i.e., the power meter may disable extrapolation because of reduced bandwidth at the lowest ranges, etc.). If the extrapolation feature is not to be invoked, then presumably the power meter takes its measurements in a conventional way, and we don't need to describe whatever that is. One might ask if the flowchart 41 of FIG. 3 and the conventional one we haven't shown are really two separate flowcharts. In all candor, probably not. But we don't know for sure what the conventional one really is—nor would help if we did. Think of FIG. 3 as one simplified example of what would remain of the merger of the two if, after such a mereger, all the conventional non-extrapolation stuff were to be removed.

The task of flowchart 41 begins with the optional fetching or entry 42 of the time constant for the thermal sensor. That value needs to be known! A fetching can occur from memory 67 in the mount, and result in a storing of the fetched value in the time constant memory 68. An entry would probably be just storing a value supplied by the operator into the time constant memory 68.

At step 43 are taken and stored some number (say, N-many) samples of power as measured by whatever power measurement technique (differential, balanced, uncompensated for drift, etc.) is in use. In this example it is convenient (but not necessary) to have the samples spaced a constant Δt apart.

In step 44 we ask if the last N-many samples are monotonic. This is to determine if a significant change in power is at hand. If the samples are not monotonic (NO), then at step 48 the average of the last several samples (it need not be N in number!) is taken and reported as the measured value. That is, the extrapolation process is not invoked: the power meter is assumed to have, or be nearly, settled. Following that, at step 47 the oldest of the N-many samples is discarded, and step 49 takes the next sample, followed by a return to step 44.

If there has been a significant change in applied power, then at some point the last N-many samples will indeed be monotonic at step 44 (YES). Now, to the extent that the change is large, and abrupt, there is little problem with its producing monotonicity. It is fair to ask about apparent monotonicity that is the result of noise, or noise with minor but ‘real’ fluctuations in the applied signal. We have these observations in response. First, even if we accidentally invoke an extrapolation when there is not a genuine need, it almost certainly does not do any harm. The reported prediction will probably be undistinguishable from the noise there, anyway. Next, the more samples there are, the greater the immunity to such ‘accidents.’ Too many samples, however, delays the result, and widens the width needed for a pulse measurement. That delay can be mitigated by taking the samples at a faster rate. (The fly in that ointment is that for really low level signals there is often a chopper in the loop, and we can't sample faster than its loop response . . . .) Finally, one might opt for combining a small percentage threshold with the monotonic criterion, to further discriminate against noise in place of using more samples. Our investigations have suggested that five samples is good, and that 2-3% noise in a system with a τ of a millisecond or so is not a problem.

To continue, once step 44 has determined that there has been a significant change in applied power, step 45 is the extrapolation (as previously explained in connection with FIGS. 2A-B) from among the last N-many samples of the terminal value of the thermal sensors response. This measured value is thus available earlier than would be the case if a full five thermal time constants (5τ) were needed to obtain it, and allows conditions to be measured with good accuracy (to within one percent, or so) that do not persist for such a time as long as five thermal time constants. Following the extrapolation step 47 discards the oldest measurement, and a new one is taken at step 49, and the process continues.

In the event that an actual abrupt pulse maintains its new level, successive extrapolations will converge to that same level, until monotonicity is no longer present, after which a tracking manner of averaging would ensue. If, on the other hand, the applied power level changes significantly after the first extrapolation, a new condition of monotonicity will be established, and new extrapolated output produced. In the interim, some averages might have to suffice.

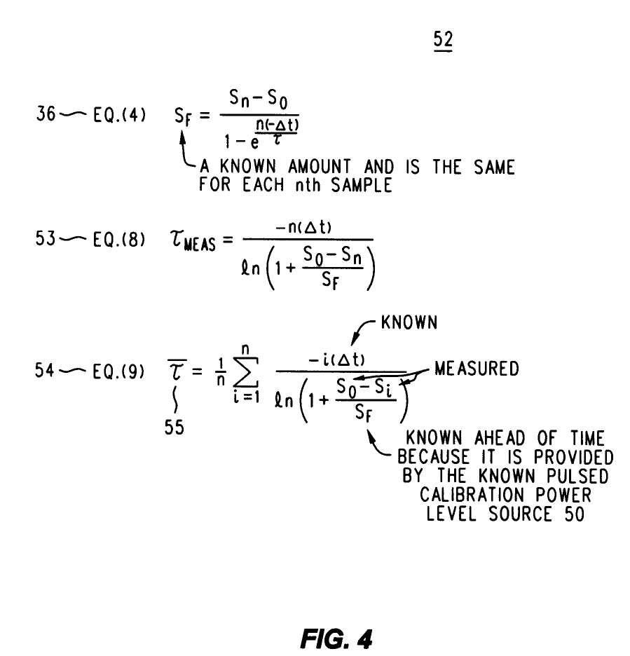

Refer now to FIG. 4, which is a simplified development, similar to that of FIGS. 2A-B, of how a thermal time constant τ may be discovered from a plurality of consecutive samples of the thermal sensor's output following the application of an abrupt step in applied power. In this case, however, we going to add the requirement that we know ahead of time what that step in power is. For simplicity, recall the discussion of the Known Pulsed Calibration Power Level source 50 in connection with FIG. 1, and assume that the power goes from OFF to ON with a duty cycle of about 50% and with rise and fall times that are sufficiently fast that no difference would be made if they were any faster. (That is probably about one tenth the expected least value of τ, which, as far as rise and fall times for RF pulses are concerned, is not particularly fast. Faster still would do no harm.) Let the duration of each ON and OFF portion be at least long enough that all n-many samples can be taken during that portion: (N+1)-many Δt's should be long enough for N-many samples Δt apart. (N+2)-many is guaranteed safe, at the price of minor overkill.

Now, we should like to take several samples within the first time constant. ‘Several’ could be two (at a bare minimum) or three, or perhaps five. Five is good. We don't know for sure how long one time constant is, but we can be pretty sure that it is not any shorter than, say, fifty micro-seconds. So, we might try to set a trial Δt to ten micro-seconds, if the hardware supports that. If it does not, then we will simply have to set it at the minimum value that is available. A similar concern arises if some element in the sensor's response loop limits bandwidth to less than that which is equivalent to sampling every ten micro-seconds (50 KHz). In that case, we go as fast as we can, and realize that we may be about to characterize the whole loop, and not just the sensor. So, we have selected trial Δt to accommodate a short time constant. But suppose it is long. A short trial Δt does not hurt anything, so long as we are prepared to take enough samples to pretty much cover the first time constant. Surely that is less than ten milliseconds. So an upper limit on a trial N is about one thousand.

That seems like a practical number, in that storing that many number is not a lot of memory, as memory usage goes these days. But we have another issue to worry about. Let's say we do take all thousand. Regardless of the size of the time constant, there is a good chance that many of those samples are too close together on the real signal to be properly different in their sampled values: it may happen that not enough precision is available to let us sample so finely, and then ‘add up the pieces to get it all back,’ as it were. We are going to be doing arithmetic with differences, and if Sₙ and Sₙ₊₁ are truncated to the same value to produce a zero difference, it does not mean that there really is NO contribution, just that we failed to capture it. By the time n changes enough to produce a difference in the Sₙ, there may be no mechanism to recapture a contribution that got rounded down to zero because of insufficient precision.

Rather than run the risk of corrupting the computations, we prefer to examine our record of trial samples and pick out the two, three, five (or whatever) samples taken that are equally spaced and that are located somewhere within, or that contain, the first time constant (or nearly so—it could be the second half time constant, or the first one and half time constants, or whatever, and it would not matter). That is, find some number of equally spaced points in the record of trial samples that describe the first 63% (or so) of the journey toward what the (known ahead of time) changed power level is going to be after settling, say from some OFF (a latest minimum value in the list) to a known ON (an earliest maximum in the list subsequent to the OFF value). We grab those equally spaced consecutive points, say five of them, note the Δt between each of them, throw the rest away and say we have our N-many samples each Δt apart that ‘come from’ the first time constant. It is as if we knew the time constant ahead of time, and practiced ‘smart sampling’ up front, as it were. (One could say that we actually sampled wastefully, and only got smart after the fact.) It is at this point we revisit Eq. (4) in FIG. 4 and ask how to find τ instead of S_{f} or Sₘₑₐₛ.

Other than the requirement that we know the applied pulsed power (by connecting the mount 26 to source 50, and perhaps by specifying the ON power level by signal 51), the other initial assumptions are basically the same as for power measurement. In fact, we shall begin FIG. 4 with a re-visitation of Eq. (4) (36), and pick up in the middle, so to speak, of Figure Two's business, but then steer it in another direction.

We note that in Eq. (4) the quantity S_{f} is a known amount, and is the same for each of the samples. S_{f} is the terminal value for the applied step, and it is what we were interested in for the extrapolation operation. S_{f} is in this case already known, (since we s applying a step that is known), and what we want to do is re-arrange things to find τ.

As before, we omit the gory details of the algebra (no special tricks are needed, and it is only about half-dozen lines at one step per line). The result of solving Eq. (4) for τ (which we call τₘₑₐₛ, since that is what it is . . . ) is shown as Eq. (8) (53). Once again, we are assuming that Δt is constant, and that to do so is merely a convenience. A single value τₘₑₐₛ would be for just two samples and a single Δt. We have presumably made (selected after the fact?) several samples within or over the vicinity of the first time constant, and prefer to find an average of the various resulting values of τₘₑₐₛ (each of which ought, in principle, to be the same), as is shown in Eq. (9) ((54) and (55)).

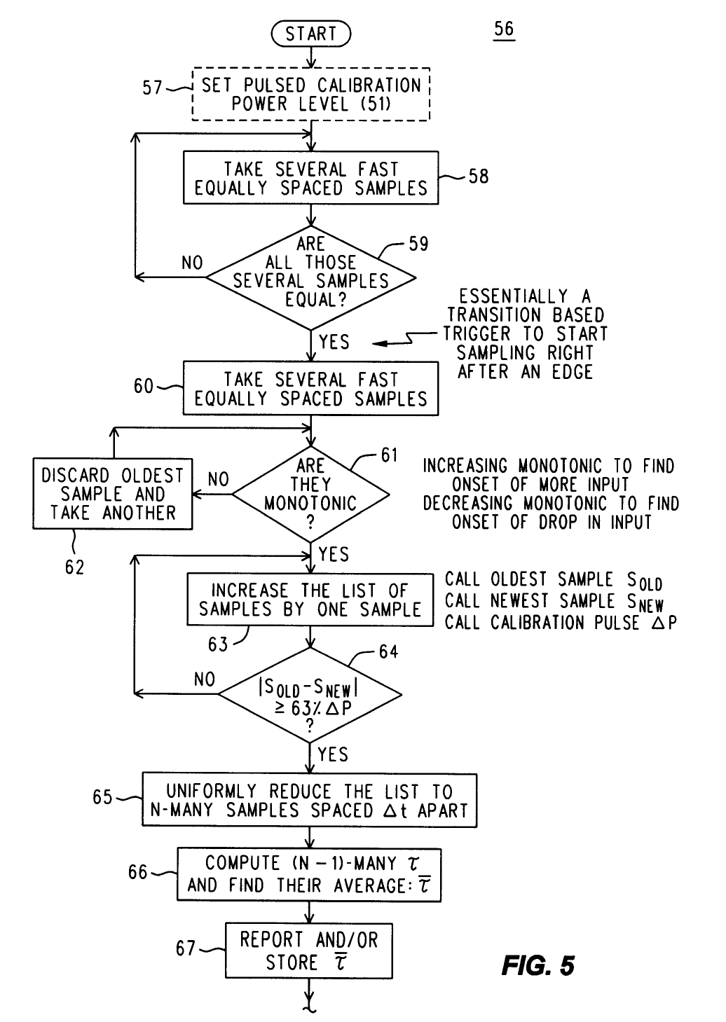

We turn now to FIG. 5, which is a simplified flow chart 56 of how a thermal time constant τ may be discovered using the Known Pulsed Calibration Power Level source 50, to which we assume that the mount 6 has been connected. At the first step 57 is the optional operation of setting the pulsed power level, if it is to be other than always the same. The idea here is that one might be inclined to discover τ at about the level a measurement of interest is going to be made at. In principle, it ought not matter, but in practice, one might be curious to know if there is a difference, anyway.

Steps 58 and 59 constitute a loop that samples several times and waits until the equality of those several samples indicates that they were taken somewhere other than on an edge.

Now we start looking for an edge with steps 60 and 61. It is a loop that takes several samples in the hope that they will be monotonic (remember, we are sampling fast enough to experience the time constant as a gradual transition . . . .) If they are not monotonic, then there is no edge, and we discard at step 62 the oldest sample and take another new one. If they are monotonic and increasing, then we have our edge at the onset of the pulse.

At step 63 we begin in earnest, by construing the samples already in hand as a short list and adding a new sample on to the end to make the list one sample longer. Now we ask at step 64 if the values in the list cover what would appear to be one time constant (63%). If the difference between the oldest and newest samples does not rise to 63% of what we know the sensor is experiencing (S_{f}), then we dwell at step 63, adding to the list, until the list is long enough to show that.

At step 65 we get the list down to a convenient size of N-many samples spaced some Δt apart. Our list might have several hundred samples in it, and we are perhaps suspicious of the quality of their individual contributions, as mentioned earlier. This operation (step 65) might involve simply taking every j^{th} entry in the list to get a suitable number N thereof, and taking note of what the resulting Δt is (j times the time between the fast samples of steps 60 and 63). Whether or not we nail the ends of the first time constant exactly is not an issue; we'll settle for N-many that are in the vicinity, as previously explained.

Now we are in a position to compute at step 66 (N−1)-many values of τₘₑₐₛ and then find their average. At step 67 we report and or store that average value of the discovered thermal time constant (tau) for use by the extrapolation mechanism explained above. The stored value of τ might be either an un-averaged single value or the average of several values, as shown. The places where that value can be stored include a register or other memory (68) set aside in the power meter for that purpose, or, in non-volatile memory 67 (e.g., flash memory) located in the mount 26 for that purpose, and which places can be interrogated later to provide the thermal time constant needed to perform extrapolation during power measurements occurring during the ordinary course of use.

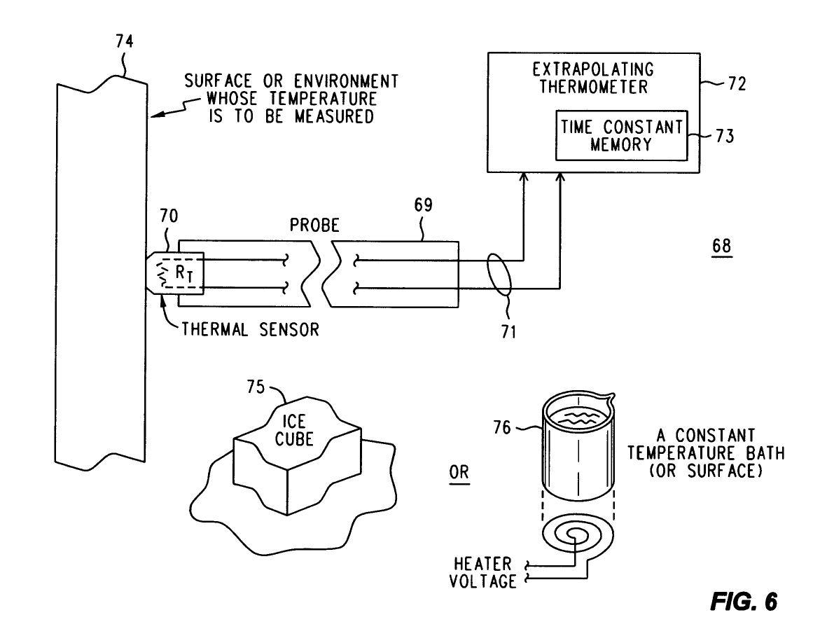

Refer now to FIG. 6, which is a simplified block diagram 68 of an electronic thermometer that extrapolates temperature values when a significant change in temperature is detected, and that may also discover the thermal time constant of its temperature probe 69. Probe 69 includes a thermal sensor 70 of some sort (e.g., thermistor, thermocouple, or RTD,—a Resistance Temperature Device that might be a platinum wire). Some thermal time constant will be associated with bringing the sensor 70 to its final settled amount when it is brought into contact with a surface to be measured (74). Suitable conductors 71 connect the probe 69 to an extrapolating thermometer 72, which contains a time constant memory 73. We omit any detailed description of what the basic measurement activity inside the thermometer 72 is like, as that is notoriously well known (essentially it amounts to a DMM, or Digital Multi-Meter). What we do want it to do is modify the way it presents measured results. It is clear that this readily done in a manner similar to what was previously described in FIG. 3 for the RF power meter case. One possible difference in the temperature case is that signal levels are robust, and the amount of resolution required is not affected by a potentially poor signal to noise ratio on low and very sensitive ranges. This pleasant state of affairs may allow the extrapolation algorithm to simply run all the time, with the consequence that qualifier 44 and its NO branch to step 48 can be emitted, or simply eliminated.

The thermal time constant for a thermometer's thermal probe/sensor (69/70) can also be discovered by the thermometer (72). As an example, consider starting with the sensor at some temperature, preferably above freezing but not so hot as to boil water (‘room temperature’ is good), and with an ice cube 75 or some constant temperature bath 76 on hand. (Of course, the bath might also be a surface, instead.) One would then initiate the discovery sequence on the thermometer and then press the probe's sensor 70 firmly against the ice cube 75 (or immerse it in the bath 76). Consider the case of the ice cube. The surface of the ice cube in contact with the thermal sensor 70 will become, and remain, water at the triple point, which is a known temperature, and that serves as the known-ahead-of-time S_{f} in Eq. 36 in FIG. 4. The major difference needed in the flowchart of FIG. 5 for the ice cube example is that step 61 would most likely look for monotonically decreasing values. Of course, the constant temperature bath 76 might be heated and ‘hot,’ or cooled and ‘cold,’ (we show it being heated) depending upon the application and the nature of the sensor 70. In any event, the time constant discovery process would need to know the destination temperature that was associated with what the user planned to use: the ice cube 75, the bath 76, or something else.

I claim:

1. A method of measuring a quantity with a thermal sensor, the method comprising the steps of:
(a) taking a plurality of samples of an output from the thermal sensor and that are indicative of the amount of the measured quantity; and
(b) extrapolating from among that selected number of samples to find and report an extrapolated value of the measured quantity, the extrapolated value based on an exponential relationship for a thermal time constant for the response of the thermal sensor.

2. A method as in claim 1 further comprising a step (a.1) of determining, by comparing the values of a selected number of the plurality of samples taken in step (a), if a significant change has occurred in the quantity being measured, and wherein the performance of step (b) is conditioned upon an affirmative determination by step (a.1).

3. A method as in claim 1 wherein the quantity being measured is RF power.

4. A method as in claim 1 wherein the quantity being measured is temperature.

5. A method of measuring applied RF power with a thermal sensor, the method comprising the steps of:
(a) taking a plurality of samples of an output from the thermal sensor and that are indicative of the amount of applied RF input power;
(b) determining, by comparing the values of a selected number of the plurality of samples taken in step (a), if a significant change has occurred in the amount of applied RF power;
(c) if the determination of step (b) is in the negative, then finding an average value associated with that selected number of samples, and reporting it as the measured applied RF power; and
(d) if the determination of step (b) is in the affirmative, then extrapolating from among that selected number of samples to find and report an extrapolated value of measured applied RF power, the extrapolated value based on an exponential relationship for a thermal time constant for the response of the thermal sensor.

6. A method as in claim 5 wherein the extrapolated value reported is the average of a plurality of individual extrapolations, each made from a respective pair of samples from within the plurality of samples taken in step (a), one member of each pair of samples being the same sample, and the other member of each pair being a different sample.

7. A method as in claim 5 wherein a majority of the plurality of samples taken in step (a) occur within a initial thermal time constant beginning at the onset of a significant change in the amount of applied RF power.

8. A method as in claim 5 wherein the plurality of samples taken in step (a) are equally spaced apart in time.

9. A method as in claim 5 further comprising a step (e) of repeating steps (a) through (d) and wherein the plurality of samples taken in a first instance of step (a) are a disjoint set from the plurality of samples taken in a second instance of step (a).

10. A method as in claim 5 further comprising a step (e) of discarding at least one earliest sample taken in step (a) and a step (f) of repeating steps (a) through (d) and wherein the remaining plurality of samples taken in a first instance of step (a) are supplemented by at least one corresponding new sample taken in the second instance of step (a) to replace the discarded at least one earliest sample, and the set of samples for the first and second instances of step (a) have common samples arising from the first instance of step (a).

11. A method as in claim 5 further comprising the steps of storing the value of a thermal time constant in an assembly containing the thermal sensor and retrieving that stored value to perform the extrapolation of step (d).

12. A method of extrapolating the final asymptotic value Sₑₓₜ of a significant change an amount of applied RF power measured with a thermal sensor, the method comprising the steps of:
(a) taking an ordered plurality of consecutive and equally spaced in time samples, S₀, S₁, . . . Sₙ, of an output from the thermal sensor and that are indicative of the amount of applied RF input power;
(b) comparing the values of a selected number of samples from within the ordered plurality taken in step (a);
(c) if the selected number of samples compared in step (b) are monotonic:
(c1) then computing the n-many values Fₙ=(Sₙ−S₀)/(1−ε^{(-Δtn/τ)}), where τ is a thermal time constant associated with the thermal sensor;
(c2) and then computing the average F_{avg} of the Fₙ; and
(c3) and then reporting the extrapolated value Sₑₓₜ=S₀+F_{avg} as the measured amount of applied RF power.

13. A method as in claim 12 further comprising the step of:
(c4) else, finding an average value associated with the selected number of samples, and reporting that average as the measured amount of applied RF power.

14. A method as in claim 12 wherein a majority of the ordered plurality of samples taken in step (a) occur within a initial instance of the thermal time constant τ beginning at the onset of the significant change in applied RF power.

15. A method as in claim 12 further comprising the steps of storing the value of τ in an assembly containing the thermal sensor and retrieving that stored value to perform step (c1).

16. A method of measuring the thermal time constant τ of a thermal sensor, the method comprising the steps of:
(a) applying to the thermal sensor an RF signal whose power level varies abruptly by a known amount between first and second power levels, at least one of which is a known power level;
(b) taking a plurality of samples of an output from the thermal sensor indicative of the power level of the RF signal;
(c) selecting a set of monotonic samples taken in step (b) that correspond to about the first 63% of the change in sensor output for samples taken by step (b) immediately subsequent to an abrupt variation toward a known power level of the RF signal applied to the thermal sensor in step (a); and
(d) computing a value τ, representing a measured thermal time constant, from a pair of samples in the set of monotonic samples selected in step (c), and according to a logarithmic relationship for a thermal time constant describing the response of the thermal sensor to an abrupt step in applied RF power.

17. A method as in claim 16 wherein the value of τ is stored in a power meter to which the thermal sensor is connected.

18. A method as in claim 16 wherein the value of τ is stored in a mount containing the thermal sensor.

19. A method as in claim 16 wherein the set of monotonic samples selected in step (c) has n-many samples S₀, S₁, . . . , Sₙ₋₁ therein and wherein step (d) comprises computing (n−1)-many values for τ, those being τ₁ computed from S₀ and S₁, τ₂ computed from S₀ and S₂, . . . , τₙ₋₁ computed from S₀ and Sₙ₋₁, and further comprising the step (e) of finding an average τ_{avg}=(1/(n−1))(τ₁+τ₂+ . . . +τₙ₋₁).

20. A method as in claim 19 wherein the samples taken in step (b) are equally spaced apart in time.

21. A method as in claim 19 further comprising the steps of storing the value of τ computed in step (d) in an assembly responsive to the thermal sensor and retrieving that stored value to perform during a power measurement for an arbitrary signal exhibiting an abrupt change in power level, and in substantially less time than 5τ, an extrapolation based on an exponential relationship involving τ of what the final settled value of the arbitrary signal will be subsequent to the abrupt change in power level.

22. A method as in claim 19 wherein the value of τ_{avg} is stored in a power meter to which the thermal sensor is connected.

23. A method as in claim 19 wherein the value of τ_{avg} is stored in a mount containing the thermal sensor.

24. A method of measuring a work temperature with a thermal sensor, the method comprising the steps of:
(a) taking a plurality of samples of an output from the thermal sensor and that are indicative of the work temperature;
(b) determining, by comparing the values of a selected number of the plurality of samples taken in step (a), if a significant change has occurred in the work temperature;
(c) if the determination of step (b) is in the negative, then finding an average value associated with that selected number of samples, and reporting it as the measured work temperature; and
(d) if the determination of step (b) is in the affirmative, then extrapolating from among that selected number of samples to find and report an extrapolated value of the work temperature, the extrapolated value based on an exponential relationship for a thermal time constant for the response of the thermal sensor.

25. A method as in claim 24 wherein the extrapolated value reported is the average of a plurality of individual extrapolations, each made from a respective pair of samples from within the plurality of samples taken in step (a), one member of each pair of samples being the same sample, and the other member of each pair being a different sample.

26. A method as in claim 24 wherein a majority of the plurality of samples taken in step (a) occur within a initial thermal time constant beginning at the onset of a significant change in the values of samples taken in step (a).

27. A method as in claim 24 wherein the plurality of samples taken in step (a) are equally spaced apart in time.

28. A method as in claim 24 further comprising a step (e) of repeating steps (a) through (d) and wherein the plurality of samples taken in a first instance of step (a) are a disjoint set from the plurality of samples taken in a second instance of step (a).

29. A method as in claim 24 further comprising a step (e) of discarding at least one earliest sample taken in step (a) and a step (f) of repeating steps (a) through (d) and wherein the remaining plurality of samples taken in a first instance of step (a) are supplemented by at least one corresponding new sample taken in the second instance of step (a) to replace the discarded at least one earliest sample, and the set of samples for the first and second instances of step (a) have common samples arising from the first instance of step (a).

30. A method as in claim 24 further comprising the steps of storing the value of a thermal time constant in an assembly containing the thermal sensor and retrieving that stored value to perform the extrapolation of step (d).
